(19) United States
(12) Patent Application Publication
(10) Pub. No.: US 2004/0010108 A1
(43) Pub. Date: Jan. 15, 2004

(54) High molecular weight polymers

(76) Inventors: Patricia A. Bianconi, Sunderland, MA (US); Scott Joray, Superior, CO (US)

Correspondence Address: FISH & RICHARDSON PC, 225 FRANKLIN ST, BOSTON, MA, 02110, US

(21) Appl. No.: 10/396,042

(22) Filed: Mar. 25, 2003

Related U.S. Application Data
(60) Provisional application No. 60/367,592, filed on Mar. 25, 2002.
(60) Provisional application No. 60/370,555, filed on Apr. 5, 2002.

(51) Int. Cl. C08G 77/00

(52) U.S. Cl. 528/10

(57) ABSTRACT

High and ultrahigh molecular weight (MW) homo- and copolymers having a three-dimensional random network structure are disclosed. The polymers have recurring structural units of the general formula [AR]ₙ, wherein A can be carbon, silicon, germanium, tin atoms, or other elements and compounds. R can be the same as or different from A (in each repeating unit), and can be hydrogen, saturated linear or branched-chain hydrocarbons containing from about 1 to about 30 carbon atoms, unsaturated ring-containing or ring hydrocarbons containing from about 5 to about 14 carbon atoms in the ring, each in substituted or unsubstituted form, polymer chain groups having at least 20 recurring structural units, halogens, or other elements or compounds. The number “n” can be at least 20, and the high MW polymers have a molecular weight of at least 10,000 daltons, e.g., about 30,000 daltons, and as high as 1,000,000 or more daltons.

### CROSS-REFERENCE TO RELATED APPLICATIONS

This application claims the benefit of U.S. Provisional Application Serial No. 60/367,592, filed Mar. 25, 2002, and U.S. Provisional Application Serial No. 60/370,555, filed on Apr. 5, 2002, the contents of which are incorporated herein by reference in their entirety.

### FIELD OF THE INVENTION

The present invention generally relates to high to ultrahigh molecular weight (MW) polymers, chemically modified high MW polymers, and materials produced from such polymers, including ceramics, crystals, alloys, and composites. The present invention further relates to methods of synthesizing and making these materials.

### BACKGROUND OF THE INVENTION

The polyacetylene class of polymers of stoichiometry [CR], have long been a focus of research due to their conductive and electronic properties, as discussed in T. A. Skotheim, Handbook of Conducting Polymers, Marcel Dekker: New York, (1986), vols 1 and 2; and J. C. W. Chien, Polyacetylenes: Chemistry, Physics, and Material Science; Academic Press, Orlando, (1984).

Recently inorganic and carbon backbone polymers of similar stoichiometry, but different structure, have been synthesized. More specifically, inorganic network polymers of stoichiometry [XR]ₙ, (e.g., the polysilynes [SiR]ₙ, the polygermynes [GeR]ₙ, and their copolymers) are known. These polymers have a continuous random network backbone, with each inorganic atom being tetrahedrally hybridized and bound via single bonds to three other inorganic atoms and one substituent. The properties demonstrated by these polymers differ from linear inorganic backbone polymers reportedly due to the characteristics conferred by the network structure.

Carbon-based network polymers of stoichiometry [CR]ₙ, are also known. One such class of carbon-based network polymers, which are referred to as polycarbynes, is described in U.S. Pat. No. 5,516,884 to Patricia A. Bianconi. This patent describes these polymers as compounds having tetrahedrally-hybridized carbon atoms, with each carbon atom bearing one substituent and being linked via three carbon-carbon single bonds into a three-dimensional continuous random network of fused rings. The polymers reportedly can form diamond or diamond-like carbon phases.

However, these known polymers have relatively low molecular weights, and are thus limited in terms of their properties. For example, these materials do not convert well to specific three-dimensional ceramics due to the significant amount of volatilization that occurs during pyrolysis. As will be readily appreciated, loss of polymer materials as volatiles during pyrolysis can result in porous and defective cast coatings and films, as well as shaped pieces.

### SUMMARY

The present invention provides high to ultrahigh molecular weight (MW) homo- and copolymers having a three-dimensional random network structure, wherein the polymers have recurring structural units of the following general formula:

[AR]ₙ

wherein A can be carbon, silicon, germanium, or tin atoms, Group 13 through Group 16 elements and compounds thereof, Group 4 metals and compounds thereof, lanthanide elements, or transition metals or combinations thereof. The Rs are the same or different (in each repeating unit) and can be a hydrogen atoms, saturated linear or branched-chain hydrocarbons containing from about 1 to about 30 carbon atoms, unsaturated ring-containing or ring hydrocarbons containing from about 5 to about 14 carbon atoms in the ring, each in substituted or unsubstituted form, polymer chain groups having at least 20 recurring structural units, halogens, Group 13 through Group 16 elements and compounds thereof, Group 4 metals and compounds thereof, lanthanide elements, transition metals, organic groups or polymers containing one or more heteroatoms of N, O or S, halogens, Group 13 through Group 16 elements, Group 4 metals, lanthanide elements, transition metals, or combinations thereof. The subscript n can be at least 20, e.g., 50, 100, 250, 500, 1,000, 1,500, 2,000, 5,000, 10,000, 50,000, 100,000, 250,000, 800,000, or more, and the polymers can have a molecular weight (MW) of at least 10,000 daltons, e.g., at least 16,000, 20,000, 22,000, 25,000, 30,000, 50,000, 100,000, 200,000, 250,000, 500,000, 750,000, 1,000,000, 2,500,000, 5,000,000 daltons, or even higher. In certain embodiments, A can be about 100% carbon, 100% silicon, or about 50% carbon and about 50% silicon, and R can be a single substituent, or R can be a mixture of different substituents. A can also be selected from a carbon atom, a germanium atom, a tin atom, an element or compound of Groups 13, 15, or 16, a Group 4 metal or compound, a lanthanide element, a transition metal, and combinations thereof, or just a carbon, silicon, germanium, or tin atom, and combinations thereof. In certain embodiments, R can be hydrogen, a methyl group, or a phenyl group.

In general, the invention features network backbone polymers or copolymers that can be converted at relatively low heat, and at ambient temperature and pressure, into ceramics, crystals, alloys, and/or composites that are diamond, diamond-like carbon (DLC), amorphous carbon, glassy carbon, and/or graphitic carbon. The invention also features methods of making the network backbone polymers, and methods to modify and craft the polymers to incorporate other metals and elements. The invention also includes methods of conversion of the polymers to form DLC ceramics and other non-carbon ceramics. The present invention also provides ionic high MW colloid-like homo- and/or copolymers, functionalized high MW polymers, as well as ceramics, composites, crystals, and alloys prepared from optionally ionic or functionalized high to ultrahigh MW polymers.

The invention further provides methods for preparing high molecular weight polymers by preparing a mixture including at least two organic, oxygen-containing solvents and a reducing agent, wherein the solvents do not chemically react with the reducing agent; homogenizing (e.g., by ultrasound) the mixture to disperse particles of the reducing agent into the solvents; and slowly adding one or more backbone atom-containing monomers to the homogenized mixture to form a reaction mixture; quenching the reaction mixture; and isolating a high molecular weight polymer. In different embodiments, the methods can include removing salts from the polymer and end-capping the polymer by reacting terminal halide sites with one or more nucleophiles, and homogenizing the mixture by irradiation with high-intensity ultrasound at a power level of between about 20 to about 475 watts.

In another embodiment, the invention features methods of preparing high molecular weight polymers by preparing a mixture including at least two organic, oxygen-containing solvents and a reducing agent, wherein the solvents do not chemically react with the reducing agent; homogenizing (e.g., using ultrasound) the mixture to disperse particles of the reducing agent into the solvents; and slowly adding one or more backbone atom-containing monomers to the homogenized mixture to form a reaction mixture; quenching the reaction mixture; and isolating a high molecular weight polymer. In these methods, the backbone atom-containing monomer can be CHBr3, RSiCl3, RCBr3, RCI3, RSnX3, and RGeX3, wherein X is a halogen, and the at least two solvents can both be ethers, e.g., tetrahydrofuran and diglyme.

In another aspect, the invention provides a method for preparing ionic or functionalized high MW homo- and copolymers by reacting one or more high MW colloid-like polymers with either: 1) one or more free radical initiators and one or more halogenating agents to produce halogenated polymers; or 2) one or more acid reagents (e.g., acid reagents having multinuclear acid anions) to produce polycationic polymers; or 3) one or more reducing agents to produce polyanionic polymers; or 4) one or more oxidizing agents to produce polycationic polymers. When halogenated polymers are produced, the method further includes reacting the halogenated polymers with one or more functionalizing agents and recovering the functionalized high MW colloid-like polymers and polymers. When polyanionic or polycationic polymers are produced, the method further includes either (a) exchanging anions or cations present in the polyanionic or polycationic polymers with ions selected from the group including halides, cyanides, nitrates, nitrosos, borates, anions (e.g., polyatomic anions, or complex anions), alkali and alkaline earth metals, transition metals and complexes thereof, cations (e.g., Group 13 cations and complex cations) and combinations thereof, or (b) reacting the polyanionic or polycationic polymers with one or more functionalizing agents and recovering the ionized or functionalized high MW polymers.

Also provided are methods for preparing ceramics, composites, crystals and alloys from the optionally ionic or functionalized high MW polymers described above. One such method includes: (a) mixing one or more of the polymers in an organic solvent or supercritical fluid to form a polymer precursor mixture; (b) applying the polymer precursor mixture to a substrate surface to form a coating or pouring the polymer precursor mixture into a mold; and (c) pyrolyzing the coating or the mixture contained in the mold under an inert atmosphere at a temperature of about 100° to 1600° C. When the polymer precursor solution is applied to the substrate surface to form a coating, the method further includes optionally repeating steps a to c to increase the thickness of the substrate coating. In these methods, the solvents can be ethers, toluene, amines, dimethyl sulfoxide, chlorocarbon solvents, and mixtures thereof, and the substrates can be silicon, silica, aluminum, alumina, magnesium, transition metal oxides, and metals.

The new high MW network polymers (or polymer clusters) overcome the disadvantages attributed to lower molecular weight network polymers. The high MW colloid-like polymers have three-dimensional random network structures, and can be functionalized high MW colloid-like polymers. Novel materials (e.g., ceramics, composites, crystals and alloys) can be prepared from optionally ionic or functionalized high MW polymers. In addition, diamond or diamond-like carbon (DLC) or other ceramic (e.g., silicon carbide) coatings and films made from the new high MW network polymers are smooth, non-porous, gas-impermeable, and demonstrate improved thermal and mechanical properties.

The invention also includes methods for synthesizing high MW colloidal-type polymers, as well as methods for preparing ionic or functionalized high MW polymers. The optionally ionic or functionalized high MW polymers can be used to produce novel materials, e.g. ceramics, composites, crystals, and alloys.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features, objects, and advantages of the invention will be apparent from the description and drawings, and from the claims.

### DESCRIPTION OF DRAWINGS

FIG. 1 is a representation of an optical micrograph of a diamond-like carbon (DLC) sample taken under polarized light.

FIG. 2 is a representation of an SEM image of the DLC sample of FIG. 1.

FIG. 3 is a representation of an SEM image of the DLC sample of FIG. 1 and 2, with 10 Å of gold deposited.

FIG. 4 is a representation of a cross-sectional photograph of a DLC sample bonded to a silicon substrate.

### DETAILED DESCRIPTION

The invention provides a new class of network backbone polymers, namely—high to ultrahigh molecular weight polymers or polymer clusters. This new class of polymers includes continuous random network backbone polymers, where each atom of the backbone is bound to either: (1) two or more backbone atoms; or (2) two or more backbone atoms and one or more substituents. These materials are of such high molecular weight that they appear to consist of colloid-like polymers or polymer clusters rather than individual molecular species.

The high MW polymers have novel and unexpected properties including facile conversion to ceramics, crystals, alloys, and/or composites, of various compositions and phases, by various processes. The new high MW network backbone polymers and copolymers of the present invention include polymers having network backbone atoms connected to each other by four single bonds.

Structure, Synthesis, and Characterization of the High MW Polymers

The high MW polymers of the present invention have recurring structural units of general formula [AR]ₙ. Substituent A can be carbon, silicon, germanium, or tin atoms, Group 13 through Group 16 elements and compounds thereof, Group 4 metals and compounds thereof, lanthanide elements, transition metals, or combinations thereof. Substituent R can be the same as substituent A, or different, and is selected from the group of hydrogen atoms, saturated linear or branched-chain hydrocarbons containing from about 1 to about 30 carbon atoms, unsaturated ring-containing or ring hydrocarbons containing from about 5 to about 14 carbon atoms in the ring, each in substituted or unsubstituted form, polymer chain groups having at least 20 recurring structural units, halogens, Group 13 through Group 16 elements and compounds thereof, Group 4 metals and compounds thereof, lanthanide elements, transition metals, or organic groups or polymers (containing one or more heteroatoms of N, O, or S, Group 13 through Group 16 elements, Group 4 metals, lanthanide elements, transition metals) or combinations thereof. Within each repeating unit, R can be the same or different than A. In some embodiments, A is 100% carbon, 100% silicon, or 50% carbon/50% silicon (by atom).

The degree of polymerization of the inventive polymers is defined by “n”, with n being at least about 20, e.g., 100, 1,000, 1,500, 2,000, 10,000, 25,000, 50,000, 100,000, 250,000, 500,000, 750,000, or 1,000,000. The upper limit of n can even be greater than 8,000,000. For carbyne polymers, n can be greater than or equal to about 800,000. The number “n” is typically determined by measuring the molecular weight of a polymer, determining the A and R substitute in the [AR]ₙ formula, and then calculating n based on the atomic weight of A and R. For example, if A is carbon and R is hydrogen, the atomic weight of CH=13. Thus, n=MW/13.

Although various methods are known to measure MW, to some extent the value of MW depends on the method used. Thus, as used herein, MW is measured using matrix-assisted laser desorption/ionization mass spectrometry (MALDI-MS), which is described in further detail below. This method is known to provide the most accurate measure of MW. Some of the measurements made herein were made using gel permeation chromatography (GPC) to provide a measure of MW. The measurements by GPC typically provide a MW value within about 5% of the value measured by MALDI-MS, and are thus also quite accurate.

Mass Spectrometry (MS) has been used for the analysis of molar masses of molecules for the past 50 years. However, the application of MS to large biomolecules and synthetic polymers has been limited due to low volatility and thermal instability of these materials. These problems have been overcome to a great extent through the development of soft ionization techniques such as chemical ionization (CI), secondary-ion mass spectrometry (SIMS), field desorption (FD), fast atom bombardment (FAB), and MALDI-MS. The MALDI-MS technique, in particular, allows for the mass determination of large biomolecules and synthetic polymers of molar mass greater than 200,000 Daltons (Da) by ionization and vaporization without degradation.

MALDI-Time Of Flight (TOF) mass spectrometry is an emerging technique offering promise for the fast and accurate determination of a number of polymer characteristics. The MALDI technique is based upon an ultraviolet absorbing matrix. The matrix and polymer are mixed at a molecular level in an appropriate solvent with a ˜10⁴ molar excess of the matrix. The solvent prevents aggregation of the polymer. The sample/matrix mixture is placed onto a sample probe tip. The solvent is removed under vacuum conditions, leaving co-crystallized polymer molecules homogeneously dispersed within matrix molecules. When the pulsed laser beam is tuned to the appropriate frequency, the energy is transferred to the matrix, which is partially vaporized, carrying intact polymer into the vapor phase and charging the polymer chains. Multiple laser shots are used to improve the signal-to-noise ratio and the peak shapes, which increases the accuracy of the molar mass determination.

In the linear TOF analyzer (drift region), the molecules emanating from a sample are imparted identical translational kinetic energies after being subjected to the same electrical potential energy difference. These ions will then traverse the same distance down an evacuated field-free drift tube; the smaller ions arrive at the detector in a shorter amount of time than the more massive ions. Separated ion fractions arriving at the end of the drift tube are detected by an appropriate recorder that produces a signal upon impact of each ion group. The digitized data generated from successive laser shots are summed yielding a TOF mass spectrum. The TOF mass spectrum is a recording of the detector signal as a function of time. The time of flight for a molecule of mass m and charge z to travel this distance is proportional to (m/z)^{1/2}. This relationship, t˜(m/z)^{1/2}, can be used to calculate the ions mass. Through calculation of the ions' mass, conversion of the TOF mass spectrum to a conventional mass spectrum of mass-to-charge axis can be achieved.

The polymers of the present invention have molecular weights of at least 10,000, e.g., at least 30,000, as measured by MALDI-MS, although they can have much higher MWs. It is further noted that the majority of the polymer solutions prepared as described herein do not pass through a 0.2 micron filter, leading to a conclusion that absolute molecular weights may be 100,000,000 daltons or more. This is in contrast to previously reported network backbone polymers, which have molecular weights ranging from about 800 to about 8,000 daltons.

In one embodiment of the present invention, each atom of the backbone is tetrahedrally-hybridized and bound via single bonds to either three other backbone atoms and one substituent, or four other backbone atoms. The phrase “tetrahedrally-hybridized” means that each network backbone atom in the polymer backbone bonds to four other atoms, either backbone or substituent atoms, which are dispersed around the network backbone atom in an approximately tetrahedral geometry. This is also known as “sp³—hybridized,” meaning that the bonds to the four other atoms are formed using the network backbone atom's four sp³ atomic orbitals. While many of the preferred network backbone polymers may contain a small amount of “trigonally-hybridized” or “sp²-hybridized” network backbone atoms as impurities, the backbones of these polymers are composed primarily of the tetrahedrally-hybridized network backbone atoms.

A first group of possible polymers has pure R substituents, and a second group a mixture of two or more different R substituents. A third group of possible polymers results from the incorporation of inorganic and metal atoms into the network backbone. As will be readily appreciated by those skilled in the art, the other inorganic and metal atoms would adopt bonding geometries depending upon their own requirements.

Examples of inorganic and metal atoms suitable for use in the present invention include, but are not limited to, silicon, germanium, tin, lead, other Group 13 through Group 16 elements, Group 4 metals and Lanthanides (e.g., cerium, praseodymium, neodymium, promethium, samarium, europium, gadolinium, terbium, dysprosium, holmium, erbium, thulium, ytterbium and lutetium). Lanthanide elements, boron, nitrogen, phosphorous and zirconium may also be incorporated into silyne polymers. When these other inorganic and metal atoms are incorporated, the R substituent on the monomers does not necessarily change, and the R substituents identified above can be used. The substituent (if any) on other inorganic and/or metal atoms incorporated into the backbone could be any of the previously-mentioned R substituents, heteroatom-containing ligands, or nothing at all. For example, boron has been incorporated from the starting material BBr₃. When incorporated into the polymer, the Br ions are removed, and the B atoms are incorporated without any substituent. Phosphorus can also be incorporated from phosphorous-containing starting materials. It is noted that the atoms of other elements incorporated into the backbone are not necessarily tetrahedrally hybridized, but since they form weak double bonds, they are not sp²-hybridized either. Each of these elements has characteristic bonding and hybridization, which they adopt when incorporated into the polymer backbones.

A fourth group of possible polymers includes polymers having carbon or other network backbone atoms connected to the network backbone by four single bonds, these atoms thus have no R substituents. Such network backbone atoms, which can be incorporated without any R substituent, include carbon, silicon, germanium, titanium, other metal atoms, or other Group 13 though Group 16 elements.

The new methods for preparing the high and ultrahigh MW colloid-like homo- and copolymers use a combination of novel solvent systems and methods of homogenization, e.g., by sonication, such as with ultrasound. In one embodiment, a mixture of at least two organic solvents and a reducing agent is homogenized, e.g., by irradiation with high-intensity ultrasound (e.g., at 20,000 Hz) at power levels of less than about 475 watts, to produce a dispersion in which tiny particles (micron to submicron particles) of the reducing agent are dispersed in the solvent mixture. The organic solvents are oxygen-containing solvents, and are selected so as not to react chemically with the reducing agent. Useful solvents include ethers, such as tetrahydrofuran (THF), diglyme, triglyme, tetraglyme, diethyl ether, methyl ethyl ether, and any other ethers, and ketones, such as methyl ethyl ketone, diethyl ketone, and any other ketones. During (or after) homogenization, one or more backbone atom-containing monomers are slowly added to the reducing agent/solvent mixture. Due to the exothermic nature of the reaction, the backbone atom-containing monomer or monomers must be added slowly, e.g., in a drop-wise fashion, to control the rate of the reaction and avoid formation of insoluble material.

In an additional embodiment, two mixtures are prepared: a first mixture of at least two organic solvents and a reducing agent, and a second mixture of one or more backbone atom-containing monomers and at least one solvent. Both mixtures are separately homogenized, e.g., by irradiation with high-intensity ultrasound at power levels of less than about 475 watts (e.g., to avoid breakage of containers). The reducing agent/solvent mixture is then slowly added to the monomer/solvent mixture, during or after irradiation of the latter. Again, the mixing is done slowly, e.g., in a drop-wise fashion, to control the rate of the reaction.

In one embodiment, the new method further includes end-capping the synthesized polymers or polymer clusters by reacting terminal halide sites with one or more nucleophiles (e.g., alky or hydride donors) followed by a reflux reaction for a sufficient time, e.g., 5, 6, 12, 18, 24, or more hours. Without proper end-capping and refluxing procedures, acceptable high to ultrahigh MW polymers may not be produced.

To produce polymers of formula [AR]ₙ, [(A₁R₁)ₓ (A₂R₂)_{y}]ₙ, or ternary, or higher order polymers, suitable backbone atom-containing monomers include, but are not limited to, CHBr₃, RSiCl₃, RCCl₃, RCBr₃, RCI₃, RSnX₃, RGeX₃, wherein X is any halogen, and the numbers “x” and “y” can be any number, e.g., either can be 1, 20, 50, 100, 10,000 or far higher, such that x+y=n.

By way of the present invention, it has been discovered that the specific organic solvents used, and the rate and order of addition of the monomer(s) and liquid reducing agent impact the ability to obtain high to ultrahigh MW polymers. For example, for the production of poly(methylcarbyne) [MeC]ₙ, it has been discovered that the monomer(s) can be diluted and added slowly to a vessel containing the liquid reducing agent and solvents. By way of example, poly(methylcarbyne) has been prepared by slowly adding (drop-wise over a period of 60 minutes) an amount of 3.33 g (25 mmol) of 1,1,1 trichloroethane diluted with 25 ml of THF to a vessel containing the liquid reducing agent (i.e., NaK) and solvents such as THF and diglyme.

For the production of poly(ethylsilyne) and poly(methylsilyne), it has been discovered that the liquid reducing agent must be added slowly, e.g., drop-wise, for at least the first two milliliters of agents to a vessel containing the monomer(s) and a solvent. By way of example only, poly(methylsilyne) has been prepared by slowly adding (drop wise over a period of 5 minutes) an amount of 4.42 g (143 mmol) of NaK alloy in two oxygen-containing, organic solvents to a vessel containing a solvent /monomer mixture.

To obtain the high to ultrahigh MW materials of the present invention, syntheses are carried out in solvent mixtures rather than using single solvents. Because the reaction is done at between room temperature and up to the boiling point of the solvents using, consideration of the reactivity of the monomers and the power of solvation of the solvents must be taken into account, and the proper solvent mixture selected to obtain ultrahigh weight molecular material. In one embodiment, when the liquid reducing agent is sodium-potassium alloy (NaK), a first solvent (e.g., an ether or ketone) would serve to reduce the NaK clusters in size, while a second solvent, which is a non-solvent for NaK clusters (e.g., the same or a different ether or ketone), would serve to control the reducing properties of these clusters so as to prevent over-reaction. The solvent mixture therefore serves to control the reducing properties of the NaK clusters, while allowing the formation of the high to ultrahigh MW species.

Suitable solvent mixtures include, but are not limited to, tetrahydrofuran (THF)/diglyme, THF/triglyme, or other ether/ketone. For example, to produce [CH]ₙ, the solvents THF and diglyme can be used in a specific ratio from about 20:1 to 4:1, e.g., 16:1, 10:1, 6:1 or 5:1 (THF:diglyme). Other ratios can be used for other monomers. Other oxygen-containing organic solvents such as triglyme and tetraglyme are also useful in the formation of ultrahigh molecular weight polymers.

Increasing the temperature will result in solvation of the polymeric material. As a further example, for the synthesis of ultrahigh molecular weight polymethylsilyne, the solvents THF and an ether or ketone can be used, with a specific ratio of about 1:1 to about 100:1.

The order of addition of the solvents and when during the reaction process they are added also impact the ability to obtain high MW polymers. For example, for the production of poly(ethylsilyne) and poly(methylsilyne), in which a THF/ether solvent mixture can be employed, the reaction must be initiated in an ether and/or ketone or a mixture of two or more such solvents, followed by the addition of a liquid reducing agent (e.g., NaK). Several minutes later, THF is added to this reaction mixture. Deviations from this order of addition of solvents could result in uncontrolled polymerization, with no acceptable product being obtained.

Liquid reducing agents, suitable for use in the new methods include, but are not limited to, sodium-potassium alloys, sodium amalgam, metals in liquid ammonia, polyaromatic anions, and other reducing metal amalgams and alloys.

The mixtures prepared in accordance with the new methods (i.e., mixtures of organic solvents and a liquid reducing agent; or mixtures of backbone atom-containing monomers and a first solvent) are homogenized, e.g., by irradiation with high-intensity ultrasound (e.g., at 20 kHz), e.g., at power levels of less than about 475 watts. While in general, the addition of more energy to a reaction drives it further toward completion, and is expected to yield materials of higher molecular weight, it has been discovered that a maximum energy input exists for the production of high and ultrahigh MW materials. In different embodiments, power levels of from about 20 to about 475 watts, e.g., 50, 100, 200, 300, or 400 watts, are employed.

In all embodiments, the high to ultrahigh MW polymers should be quenched to complete the reaction with the reducing agent. The quenching is typically done with water or other aqueous solvent that does not contain any alcohol. For example, it is known that polysilynes are typically quenched in methanol. However, high and ultrahigh MW polysilynes, prepared by the new methods react violently with any alcohol and are destroyed. The fact that high MW polysilynes cannot be quenched with alcohol is therefore surprising. However, in spite of the fact that water is more reactive toward such polymers than is alcohol, high MW polysilynes can be quenched with water.

Modification of High MW Polymers

The present invention also provides methods for preparing ionic or functionalized high to ultrahigh MW colloid-like homo- and copolymers and polymer clusters. More specifically, the invention provides means for ionization or functionalization of the new polymers with groups that will alter the functions not only of the polymers, but also of the DLC and ceramic end-products as well. Such chemically modified high MW polymers constitute an additional novel class of materials with novel end-use applications.

By way of example, the high MW polymers of the present invention can be ionized or functionalized using: (1) vinylic or actetylinic groups, oligomers, or polymeric side chains to provide or enhance photoconductive properties for optoelectronic applications; (2) dopant elements (e.g., Group 12 through Group 16 elements) to tune semiconductivity of a resulting ceramic by altering Fermi levels for the purpose of producing new electronic or optoelectronic materials or devices; (3) cyano, amide, or other groups with functional atoms (e.g., Group 15 through 17), or the like, to alter pH for the purpose of altering solubility, optoelectronic properties, or to increase material compatibility; and/or (4) functional groups, oligomers, or polymeric side chains to provide ceramic end-products with biostealth properties (e.g., interference with protein/biopolymer bonding) for applications such as biological and technical antifouling coatings

The methods for chemically modifying the new high MW polymers can be broadly described as reacting one or more high MW polymers with either: 1) one or more free radical initiators and one or more halogenating agents to produce halogenated polymers or polymer clusters; 2) one or more acid reagents (preferably acid reagents having multinuclear acid anions) to produce polycationic polymers; 3) one or more reducing agents to produce polyanionic polymers; or 4) one or more oxidizing agents to produce polycationic polymers, wherein, when halogenated polymers are produced, the method further includes reacting the halogenated polymers with one or more functionalizing agents and recovering the functionalized high MW polymers. When polyanionic or polycationic polymers are produced, the method further includes either (a) exchanging anions or cations present in the polyanionic or polycationic polymers with ions selected from the group including halides, cyanides, nitrates, nitrosos, borates, anions (e.g., polyatomic anions, complex anions), alkali and alkaline earth metals, transition metals and complexes thereof, cations (e.g., Group 13 cations and complex cations) and combinations thereof, or (b) reacting the polyanionic or polycationic polymers with one or more functionalizing agents and recovering the ionized or functionalized high MW colloid-like polymers.

In one embodiment, high MW polymers having fairly easily-removed R substituents, such as [CH]ₙ, are dissolved in any suitable solvent and reacted with one or more free radical initiators and one or more halogenating agents to produce halogenated polymers. The halogenated polymers are then reacted with one or more functionalizing agents and the functionalized high MW polymers recovered.

Suitable free radical initiators for use in the method described above include 2,2′-azobisisobutyronitrile (AIBN) and peroxides, especially sterically hindered peroxides, while suitable halogenating agents include N-bromosuccinimide, N-chlorosuccinimide, bromine, chlorine, and various chlorocarbons. In one embodiment, the free radical initiator is AIBN and the halogenating agent is N-bromosuccinimide.

In another embodiment, high MW polymers having phenyl R substituents, such as [SiPh]ₙ, are dissolved in any suitable solvent and reacted with one or more acid reagents to produce polycationic polymers. The polycationic polymers are then reacted with one or more functionalizing agents and the functionalized high MW polymers recovered.

Suitable acid reagents are non-oxidizing acid reagents such as HX acids, with X=Group 17 elements, borate acid, trifluoromethanesulfonic acid and the like, with some acid reagents being multinuclear acids such as trifluoromethanesulfonic acid or triflic acid.

In certain embodiments, high MW polymers are dissolved in a suitable solvent and reacted with one or more reducing agents to produce polyanionic polymers. The anions present in the polyanionic polymers are then exchanged with ions selected from the group including halides, cyanides, nitrates, nitrosos, borates, anions (e.g., polyatomic anions, complex anions), alkali and alkaline earth metals, transition metals and complexes thereof, cations (e.g., Group 13 cations and complex cations) and combinations thereof, and the ionized high MW polymers recovered.

Suitable reducing agents for use in the new methods include borohydrides (e.g., K-SELECTRIDE® borohydride), Group 2 hydrides, potassium hydride, sodium hydride, and the like, with a preferred reducing agent being potassium hydride.

In another embodiment, high MW poly(hydridocarbyne) ([CH]ₙ or (PHC)) is dissolved in tetrahydrofuran (THF). A potassium hydride/THF solution is then added to the PHC/THF solution in a 1:3 molar ratio and the resulting reaction mixture stirred under argon for 96 hours. The reaction mixture is then quenched by addition of water and the solvent removed under vacuum. The resulting polymeric material is then washed with tetrahydrofuran, which produces a dark solid.

Chemical analysis shows that the water-soluble polymer produced by way of this method contains approximately 14% by weight potassium ions and no sodium ions. The polymer therefore consists of a [CH]ₙ backbone that has accepted multiple electrons from the reducing agent and is now polyanionic, with potassium cations present to preserve neutrality. The formula for this ionized polymer is (K⁺)ₓ([CH]ₙ^{-x}).

Ionized polycarbynes, having all-carbon backbones and being water-soluble are presumably biocompatible and non-toxic. These materials could therefore be used to form conductive protective layers on implants, being more biocompatible than conductive layers prepared from inert ceramics.

In an additional embodiment, high MW polymers are dissolved in a suitable solvent and reacted with one or more oxidizing agents to produce polycationic polymers. The polycationic polymers are then reacted with one or more functionalizing agents and the functionalized high MW polymers recovered. Suitable oxidizing agents for use in the present inventive method include chlorine, chlorites, chlorates, halogens (e.g., bromine), hypochlorites, nitrates, perchlorates, peroxides, transition metal oxides and the like, with a preferred oxidizing agent being sodium hypochlorite (NaOCl).

In another embodiment, high MW poly(hydridocarbyne) is hydride end-capped by either: (1) reacting the polymer with one or more hydriding agents (e.g., potassium hydride), or (2) forming an ionized polycarbyne (K⁺)ₓ([CH]ₙ^{-X}) and then removing excess electrons with an acidic or weak oxidizing agent until the polymer is neutral.

Processing of the High MW Polymers to Form Products (Ceramics, Composites, Crystals, and Alloys)

The high MW polymers of the present invention may be easily converted to diamond-like carbon (DLC) and other hard, ceramic materials. The structure of, for example, [CH]ₙ, a three-dimensional atomic network, with its sp³ bonding, and that of crystalline diamond are very similar, especially when contrasted with the structure of polymer networks formed by molecular repeat units. Because of this similarity in structure, the [CH]ₙ three-dimensional atomic network is easily converted to the three-dimensional diamond crystal structure. In fact, it has been found that conversion of the sp³-bonded carbon network to predominantly sp³-bonded carbon phases is favored during the conversion process.

The advantages of using the high MW network polymers and polymer clusters of the present invention to produce DLC materials include the ability to operate from the liquid state. The high MW network polymers are soluble in, e.g., organic solvents and supercritical fluids, and can be converted in situ into coatings or films. Other advantages include the ability of the polymer precursor solution to penetrate a matrix, such as a carbon fiber matrix, to produce DLC or hard carbon reinforcing filler upon pyrolysis. In addition, the polymer precursors undergo a photo-oxidation reaction so that it may be photo-patterned.

U.S. Pat. No. 5,516,884 to Patricia A. Bianconi, which has been incorporated herein by reference, describes that DLC or hard carbon materials can be formed by pyrolysis of the poly(phenylcarbyne) [PhC]ₙ class of network polymers. As noted above, these polymers are relatively low molecular weight (i.e., from about 800 to about 8000 daltons) network polymers. These materials volatilize during heating and annealing, which results in low ceramic yields of about 20 to about 30% by weight, based on the total weight of the poly(phenylcarbyne) starting material, and coatings or films of these materials display numerous surface defects in the form of large holes, cracks, and pores.

In contrast, the present invention provides smooth, non-porous, gas-impermeable diamond-like coatings and films that have improved thermal and mechanical properties. The present invention, in a more general sense, provides diamond or DLC materials, and other hard, ceramic materials, prepared from high MW colloid-like polymer clusters and network polymers, as well as methods for preparing such materials.

One such method includes: 1) dissolving one or more high MW polymers in an organic solvent or supercritical fluid to form a polymer precursor solution; 2) applying the polymer precursor solution to a substrate surface to form a coating, or pouring the polymer precursor solution into a mold; and 3) pyrolyzing the coating, or solution contained in the mold, under an inert atmosphere at temperatures ranging from about 100° C., e.g., 150, 200, 250, to about 1250°, 1500°, or 1600° C., wherein, when the polymer precursor solution is applied to the substrate surface to form a coating, the method further includes optionally repeating steps 1 to 3 to increase the thickness of the substrate coating.

In one embodiment, the inventive method further includes heating the coating, or solution contained in the mold, to a temperature ranging from about 100 or 120, e.g., 190, to about 210° C. at a rate of from about 0.1 to about 1.0° C./minute, prior to pyrolyzing the coating or solution.

The polymer precursor solution may be applied (e.g., coated or painted) to substrates of any size and shape, no matter how complex, since the polymer is applied from solution or supercritical fluid. This feature is important for filling small features on computer chips, or for filling small pores in porous materials (e.g., a carbon or graphite fiber matrix where pyrolysis would lead to a DLC or hard carbon reinforcing filler that permeates the matrix). The polymer precursor solution can also be poured into molds to produce shaped diamond or diamond-like parts.

Suitable organic solvents and supercritical fluids for use in the above-referenced methods include ethers such as diglyme, triglyme, and THF; toluene, liquid ammonia, other amines (e.g., triethylamine, hexamethyldiphosphoramide), supercritical carbon dioxide, and other supercritical fluids containing donor atoms such as nitrogen or oxygen and water, both liquid and supercritical; while suitable substrates include silicon, silica, aluminum, alumina, magnesium, and transition metal oxides and metals that form thermodynamically strong carbides such as titanium, tungsten, steel, tungsten, chromium, iron, zirconium, and other transition and lanthanide metals.

The new diamond-like coatings or films, as well as other non-carbon hard, ceramic coatings and films (e.g., of silicon carbide) can be smooth, non-porous, gas-impermeable films that have no individual crystals. As a result, these films can have improved thermal properties (e.g., no or little loss in thermal conductivity in the xy plane) and improved mechanical strength (e.g., no or reduced possibility of fractures that can occur along grain boundaries). Also, these films have improved surface properties and are smooth enough for use in electronics applications and as lubricating layers, since they have low coefficients of friction.

In addition, the films of the present invention are molecularly bonded to the substrate, thereby demonstrating improved adhesion between the film and the substrate. On substrates capable of forming carbides, the film produces an interlocking carbide layer between the substrate and the film, thereby reducing or eliminating loss in thermal conductivity at the film/substrate boundary.

The conversion properties and yields of the polymer precursor of the present invention, and the quality of the DLC materials obtained thereby, can be optimized by the use of different side-groups (e.g., carboxyl, cyano, chloro, and fluoro side-groups) and by more sophisticated processing techniques other than simple pyrolysis. For example, other methods of processing high MW colloid-like polymers include the following: (1) for poly(phenylcarbyne) [PhC]ₙ, removal of the phenyl (Ph) rings by reaction with ozone or hydrogen or oxygen plasma, then conversion of the remaining backbone carbons to diamond-like material by pyrolysis; (2) reaction of the polymers as films under hydrogen or hydrogen plasma at low temperatures (250° to 400° C.); (3) heating polymer films in an inert atmosphere with varying small percentages of H₂ and/or O₂; (4) all of the above procedures, carried out under pressures of >0.5 GPa; (5) all of the above procedures, at both atmospheric and the pressures given above, with the addition of seed crystals of various types (diamond and/or silicon carbide (SiC) of micron to nanometer size, or cubane or dodecahedrane species as nucleation aids; (6) treatment of polymer films with microwave radiation in the presence of an inert atmosphere or any of the reactive atmospheres given above; (7) high-power laser irradiation of polymer films or powder, in a patterned array if desired, under either an inert atmosphere or any of the atmospheres listed above; and (8) UV irradiation of the polymer films in the presence of H₂ or H₂ plasma, followed or accompanied by heating as needed up to approximately 800° C.; (9) all of the above can be done with temperature variation, from 200° C. to approximately 500° C.; (10) processing under additive atmospheres such as ammonia, other nitrogen containing gases, methane, silane, and other inorganic containing gases; (11) use of conventional chemical vapor deposition (CVD) techniques; and (12) any combination of methods and techniques including those noted above (e.g., pyrolysis in combination with (a) nucleation aids such as seed crystals and methods of scratching the substrate, (b) visible, infrared, ultraviolet, microwave, gamma ray, x-ray; and ultrasonic irradiation, under any reactive or inert atmosphere, liquid or gas, (c) electron/neutron bombardment, and/or (d) plasma treatment at any temperature.

The high MW network polymers of the present invention need not be formed of carbon alone. For example, titanium, geranium, or silicon can be introduced into the network to form a copolymer, or a terpolymer could be formed with all three. An alloy formed by the pyrolysis of a polymer of the present invention containing C, Si, and Ti atoms in the backbone produces a true alloy. The mixing occurs on the molecular level in the formation of the polymer precursor. A coating produced in this manner does not have the uniformity problems of an alloy coating that is made by conventionally combining silicon carbide and titanium carbide. A silicon-titanium-carbide alloy, or other alloy, formed in accordance with the present invention can be used as hard facings for tools. Alternatively, a germanium-silicon or germanium-silicon-carbide alloy formed in accordance with the present invention can be used in electronics, such as in solid-state circuit components.

The present invention allows DLC or hard carbon coatings to be formed over large areas. A hard carbon coating formed in accordance with the present invention can be used to coat prosthetic devices, such as joints, or even false teeth. A hard carbon or diamond film produced with the present invention can be used to coat cutting or drilling edges, pipes, graphite crucibles, magnetic disks, frying pans, polymers, clear substances, or any other object that requires wear or corrosion resistance. The coating can also be made smooth and optically transparent, forming an ideal coating for optical surfaces such as eyeglass or camera lenses. The electronic properties of diamond also make it an ideal material for producing a coating for cold cathode devices.

The following examples illustrate particular advantages and properties of the materials and methods claimed herein.

### EXAMPLES

The general materials and methods are described below, followed by specific examples of making a high MW polymer, functionalizing the high MW polymer, and methods of making ceramic films from high MW polymers.

All syntheses described below were performed under an inert atmosphere, e.g., argon or nitrogen atmosphere, by means of standard Schlenk manipulations or inside a glove box. Diglyme and tetrahydrofuran were purchased from Aldrich and were dried over sodium metal and benzophenone and distilled prior to their use. Methyltrichlorosilane (99%) and bromoform (99%) were purchased from VWR and used as received. Methylithium (1.4 M in diethyl ether) was purchased from Aldrich and used as received. Liquid 1:1 mole ratio NaK alloy was prepared in a glove box by adding solid potassium to an equimolar amount of molten sodium.

Elemental analyses of the polymers were carried out at the Microanalysis laboratory, University of Massachusetts, Amherst, using V₂O₅ as a combustion aid. Carbon and Silicon determination of the ceramics were run at Galbraith Laboratories, Knoxville, Tenn. ¹H NMR (200.1 MHz) spectra were recorded on a Bruker AC200® and a (300.3 MHz) Bruker DPX300®. ¹³C NMR (75.4 MHz) spectra were recorded on a Bruker DPX300® and on a (125.7 MHz) Bruker AMX500® using a Bruker 5 mm broad band direct probe. ²⁹Si NMR (99.4 MHz) spectra were recorded on a Bruker AMX500®, using a Bruker 5 mm broad band direct probe. The distortion-less enhanced proton transfer-45 (DEPT45) sequence was run with J=7 Hz for silicon network backbone polymers and J=15 Hz for carbon network backbone polymers. Solvents including d₆ dimethyl sulfoxide and d₈-tetrahydrofuran were used as solvents at room temperature. FTIR transmission spectra were obtained using a Midac M12-SP3® spectrometer, operating at 4 cm⁻¹ resolution with neat film samples between salt plates or with KBr pellets. Oxygen incorporation studies were done using a Rayonet RPR-100® photochemical reactor. UV/Vis spectra were measured at room temperature, in 3×10⁻⁴ M cyclohexane solution using a Shimadzu UV-260® spectrometer. The molecular weights of the polymers were determined on a Waters 1200 HPLC pump, using tetrahydrofuran as a solvent. Pyrolysis studies of PMSi and poly(hydridocarbyne) PHC were performed using a Thermolyne 12110® tube furnace; all studies were done under a dynamic argon flow and a heating rate of 10C./min. Ceramic yields are quoted as percentage weight retention. Films of PMSi and PHC were spun at 1000 rpm for 10 minutes on silicon substrates with an alumina basecoat, on a Headway Research Inc. Photo Resist spinner model 1-EC101DT-435®, from a 0.2 g/mL polymer/THF solution. Film thickness and roughness measurements were obtained using a Tencor Instruments Alpha Step 500 Surface Profiler®. Scanning electron micrographs (SEM) were taken. Energy Dispersive X-ray spectroscopy (EDS) was carried out. The XRD pattern was recorded on a Siemens D-500 diffractometer in transmission geometry with a Ni filtered CuK radiation.

### Example 1

### Preparation of PHC (Poly(hydridocarbyne))

Poly(hydridocarbyne), [HC]ₙ, (1), was synthesized in accordance with the following Equation 1 using two different methods, which are described below.

$${CHBr}_{3} {{\to }^{1.5 Molar equiv . NaK , THF , diglyme}}_{475 W , 20 kHz ultrasound} 1.5 Molar equiv . {[ HC ]}_{n} + Na ( K ) Br \qquad ( Equation 1 )$$

Procedure A

A quantity of bromoform (CHBr₃) was added to a mixture of (i) organic solvents tetrahydrofuran (THF) and bis(2-methoxyethyl)ether (diglyme) (16 parts:1 part) and (ii) liquid reducing agent sodium-potassium alloy (NaK), while agitating the reaction mixture with high-power (475 W, 20 kHz) ultrasound, in an inert atmosphere (e.g., a glove box). The reaction mixture was then removed from its inert environment and quenched in air by the addition of water. The organic layer was then separated from the aqueous layer and alcohol was added to the organic layer to precipitate the polymer out as a dark composition. Isolated yields of polymer were as high as 80% using this procedure.

The polymer may be further purified by: (i) extracting with water to remove sodium and potassium bromide salts; (ii) treating with an alkylating agent to end-cap any remaining carbon-bromine sites on the backbone; and/or (iii) irradiating with a common UV lamp to remove any traces of carbon-carbon double bonds in the backbone structure.

Spectroscopic studies (e.g., proton and carbon NMR, chemical analysis, and IR and electronic spectroscopy) demonstrated that the synthesized polymer contains an sp³-hybridized continuous random network backbone. Gel permeation chromatography (GPC) was used to determine the molecular weight of the resulting polymer as described below.

Procedure B

A 400 milliliter (ml) oven-dried beaker containing 2.33 grams (g) NaK, 200 ml THF, and 40 ml anhydrous diglyme was placed in a nitrogen atmosphere drybox equipped with a high intensity (475 W, 20 kHz, ½ inch tip) ultrasound immersion horn. The NaK solution was irradiated at 70% power by immersion of the horn into the solution for 5 minutes. A quantity of 6.32 g (25 mmol) of bromoform was then diluted with 25 ml THF and the resulting monomer solution added drop wise to the NaK solution over a period of 10 minutes. Sonication was continued for a total of 32 minutes with the reaction mixture turning a dark blue in color.

The dark blue reaction mixture was then transferred to a reflux apparatus employing a Schlenk line and 7.0 ml of methylithium (1.4 M in diethyl ether) added to the reaction mixture. Then, while vigorously stirring the reaction mixture, 5 ml of water was added to the mixture that gave a brown solid. The mixture was removed from the reflux apparatus and decanted off to remove any salts that had settled. The brown solid was separated from the remaining salts through dilutions and evaporations under vacuum. Isolated yields of polymer ranged from about 50 to about 85% using this procedure.

Characterization of (1) was performed using: (i) ultraviolet visible spectroscopy (UV/Vis); (ii) quantitative Fourier transform infrared (FTIR) spectroscopy; (iii) proton NMR (¹H NMR) spectroscopy; (iv) ¹³C NMR spectroscopy; (v) gel permeation chromatography (GPC); (vi) elemental analysis; and (vii) infrared (IR) spectroscopy. All data, which is set forth below, was consistent with the formation of (1).

FTIR (neat, cm-1 (assignment)): 2978, 2862 ((C-H, stretching), 1065 ((C-C stretching). DEPT 45 ¹³C NMR (ppm assignment): 35, very broad, (CH). ¹H NMR (ppm assignment): 1.75, very broad (CH), 3.45, broad, (CHBr). Elemental analyses: Found (C 70.42%, H 8.21%, Br<0.1%); Calculated for (CH)ₙ (C 92.3%, H 7.7%).

The UV/Vis spectrum obtained for (1) showed the presence of a network backbone polymer structure. More specifically, the UV/Vis spectrum showed a broad and intense absorption in the UV region that tailed off into the visible region at 500 nm, which is characteristic of network backbone polymers and which is attributed to extension of C—C conjugation into three dimensions.

The FTIR spectra showed a C—H stretching band at 2978 and 2862 cm⁻¹ and a C—C stretching band at 1065 cm⁻¹.

The ¹H NMR spectra showed a broad resonance centered at 1.75 ppm, attributable to hydrogen atoms bonded to a network polymer backbone. This data indicates that the repeating polymer unit of (1) is C—H, thus showing that its stoichiometry of [CH]ₙ is consistent with the network backbone configuration, formula, and structure. The ¹H NMR spectra also confirmed that the product is almost entirely (1), where the broad resonance at 1.75 ppm was accompanied by only weak resonances above 5 ppm, which may be attributable to C═C bonds acting as impurities.

The ¹³C NMR spectrum of (1) exhibited a very broad resonance centered at 25 ppm, characteristic of quaternary carbon atoms. The resonance at 25 ppm in the ¹³C NMR spectrum of (1) was enhanced when (1) was synthesized using 10 molar percent of bromoform monomer that was labeled with ¹³C. This data indicates that C═C bonds are not primary structural features of (1), and that this polymer therefore does not adopt a linear polyacetylene structure. The presence of quaternary-carbons as a primary structural feature and the broadness of the ¹³C resonances indicate that (1) consists of a randomly-constructed, rigid network of tetrahedral hydridocarbyne units.

The DEPT 45 sequence ¹³C NMR spectrum showed a broad resonance centered at 35 ppm indicating a single proton bound to a carbon networked backbone. It is noted that the DEPT 45 ¹³C NMR spectrum also showed a resonance at approximately 135 ppm, which indicates the presence of C═C bonds. The amount of C═C bonds incorporated as impurities into the polycarbyne backbone was small, however, where polyacetylene characteristic properties were not shown by way of the characterization tests described above.

GPC analysis of (1) revealed polydispersity and indicated a molecular weight range of from about 200,000 to well over 10,000,000 daltons. As such, the GPC analysis confirmed that (1) is an ultrahigh molecular weight network backbone polymer. These ultrahigh molecular weights are unprecedented for network backbone polymers, and provide novel bulk material properties that cannot be obtained with other previously reported network backbone polymers. It is noted that brown insoluble powders were also formed during the synthesis of (1) which may constitute even higher molecular weight versions of this material.

The composition of (1), as determined by elemental analysis, was 70.42% C, 8.21 % H and <0.1% Br, which was close to the expected composition.

The IR spectrum indicated that impurities might be present in (1). More specifically, a C—O—C stretching band at 1065 cm⁻¹ was observed in the IR spectrum and was attributed to some incorporation of THF into the polymer. It is noted that this band is also present in the IR spectra of previously reported network backbone polymers, which are also synthesized in THF solutions. Since no resonances attributable to incorporated THF appeared in the ¹H NMR spectra of these polymers, the amount of THF incorporation into the novel polymers of the present invention must be small. A band at 3500 cm⁻¹ was also observed and was attributed to physically absorbed water where ultrahigh molecular weight network backbone homo- and copolymers that have electron rich backbones or substituents are hygroscopic. IR bands ranging from 750-510 cm⁻¹ also appeared in the IR spectra of (1) and were attributed to C—X (X is halogen) sites that may have resulted from incomplete polymerization and/or incomplete end-capping during polymer synthesis or workup. In addition to the above, it is noted that a weak band at 1642 cm⁻¹ was also observed, indicating that C═C bonds may have formed.

### Example 2

### Preparation of Polycarboxylcarbyne ([CCOOH]ₙ)

In an example of functionalizing a high molecular weight polymer, RuO₂ H₂O (0.0133 g, 1.0×10⁻⁴ mmol, 0.002 equiv.) was added to a stirring solution of bleach (400 mL, 5.25% aqueous sodium hypochlorite) in a 1000 mL round bottom flask. Polyphenylcarbyne (1.10 g, 12.3 mmol) was dissolved in approximately 100 mL of chloroform and was added to the stirring bleach solution. Stirring was continued for 24 hours. The aqueous layer was then separated from the mixture and reduced to near dryness by vacuum. The organic layer was discarded. The aqueous residue was placed in selectively permeable membrane (dialysis) tubing and extracted with distilled water. The extraction solution was changed several times over the course of three days until no precipitate was observed upon exposure to a saturated solution of aqueous AgNO₃. The polymer solution inside the tubing was reduced to dryness under vacuum and 0.2291 g (23.5%) of [NaOOCC]ₙ was obtained as a tan, flaky residue ¹H NMR (D₂O): no observable proton resonances; IR (KBr pellet, cm-1): 3443 (s), 1629 (s), 1388 (s), 1002 (w). This residue was dissolved in approximately 30 mL of distilled water and exposed to acidified cation exchange beads for several hours. The solution was then reduced to dryness and gave 0.103 g (14%) of [CCOOH]ₙ as tan flakes. IR (KBr pellet, cm-1): 3442 (s), 2931 (w) 1734 (s), 1636 (m), 1227 (s), 1037 (m), 1009 (m).

The polycarboxylcarbyne is useful in that it releases CO₂ when pyrolyzed, e.g., when used to make a ceramic material, and is thus safer to use than ceramic precursors that produce noxious or poisonous gases. In addition, the polymer itself can be used as a fire retardant, because during a fire, it forms a ceramic, and gives off only non-toxic CO₂ gas.

### Example 3

### Preparation of DLC Coatings from High MW PHC

PHC (poly(hydridocarbyne)) (1), at pyrolysis temperatures of 1000° C., under argon, is a high yield preceramic. Thermal gravimetric analysis indicates that the polymer begins to lose weight at about 137° C., and is heated to a constant weight at 450° C., which is the point at which the polymer becomes a ceramic. Heat treatment of the polymer in argon up to 1100° C. resulted in its conversion to solid carbon in up to 88% yield (theoretical yield for this conversion is 92%). Heating a film of the polymer to 800° C. in a hydrogen atmosphere resulted in its conversion to a continuous, crack and defect free, dense film of diamond-like carbon (DLC), which was densely covered on the surface with diamond crystals of about 15-20 micrometers in size.

The films adhere strongly to any substrate that can form a carbide—the polymer and substrate form an interlocking layer of carbide between them, and so the diamond film is very strongly bound to the substrate by this intermediate carbine layer. The films are adherent to such substrates as silicon, tungsten, steel, and titanium, among others. The ceramic yield is very much dependent on the molecular weight of the polymer, which is a well-known attribute of these types of polymers. All the DLC films that were formed in this example displayed a clear and often colorless appearance.

Samples of PHC were spun on silicon substrates to obtain uniform and smooth films of PHC 2 μm thick, with a mean square roughness (Rq)=5000 Å, scanned over 2 mm. After pyrolysis, smooth ceramic films were obtained with an Rq=524 Å, scanned over 2 mm). This smoothness indicates a dense, homogeneous ceramic film. The ceramic films produced were adherent to the substrates, resistant to removal by plastic adhesive tape, and were completely uniform.

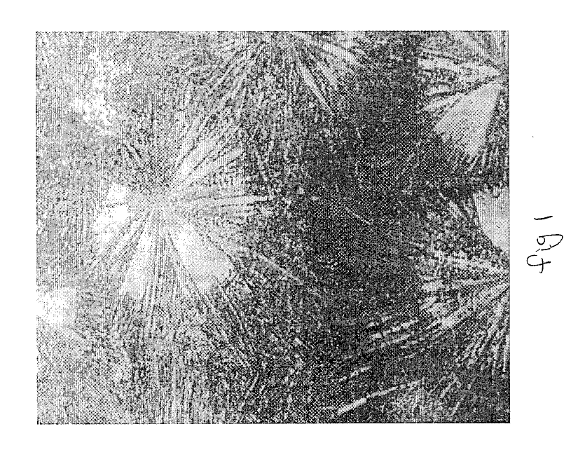

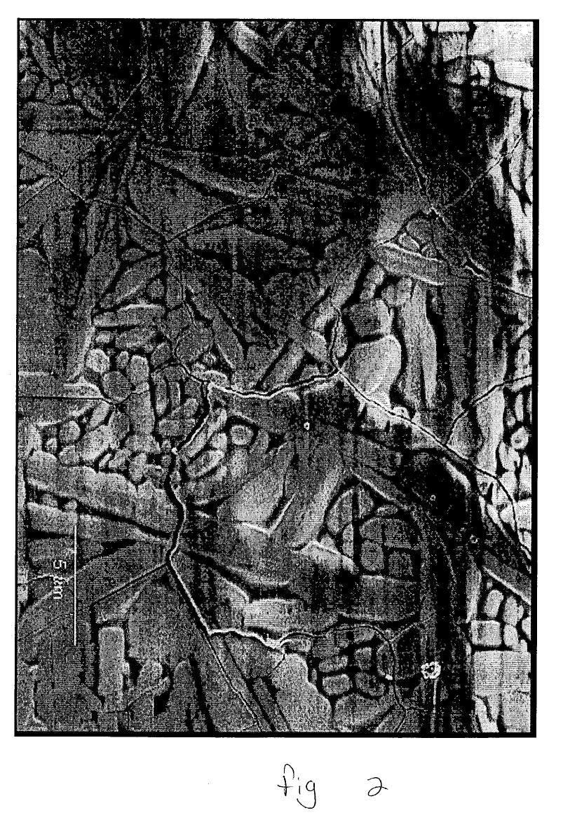

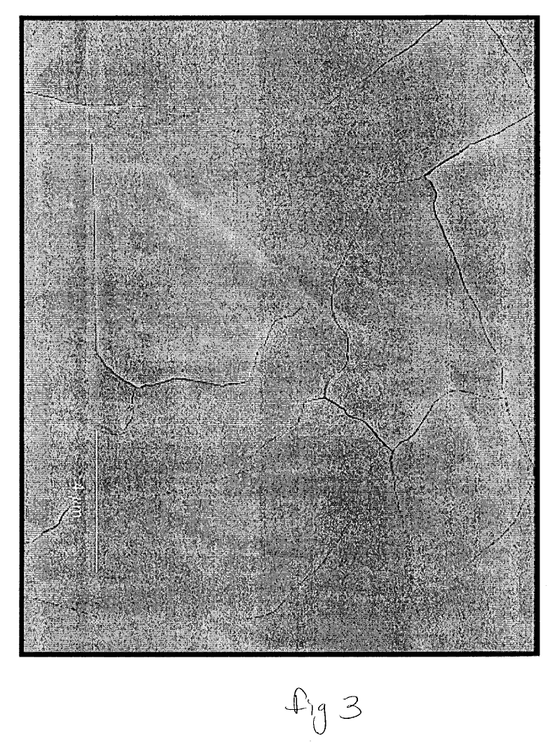

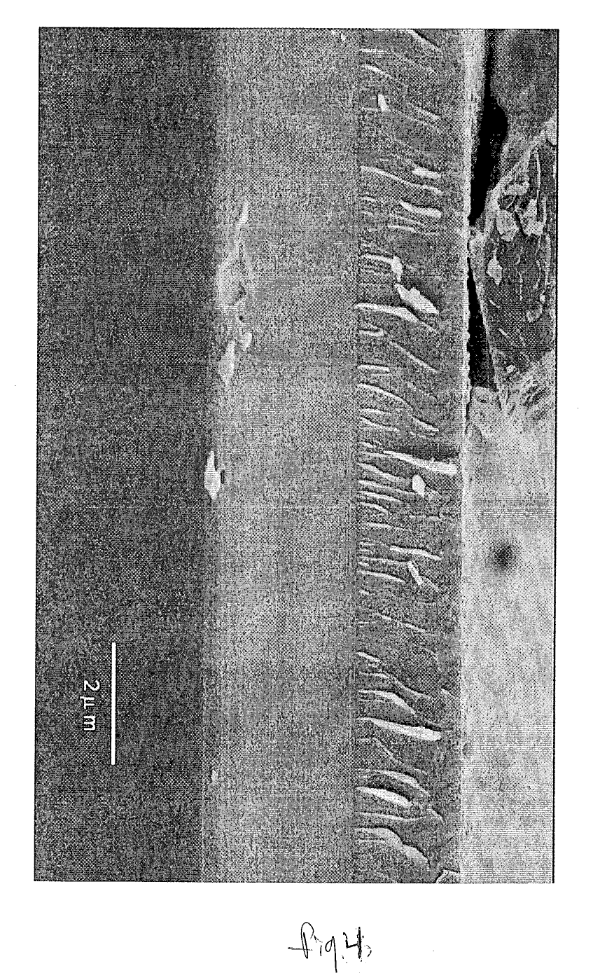

FIG. 1 is an optical micrograph of a DLC film sample taken under polarized light, and shows the crystalline structure in the DLC film. FIG. 2 is an SEM photo of the sample shown in FIG. 1, and shows the differences in surface density, because the electrons of the SEM interact with the surface. FIG. 3 is an SEM of the DLC sample of FIG. 2, with approximately 10 Å of gold deposited by vapor deposition using standard techniques. FIG. 3 thus shows a true image of the surface of the DLC film, because the thin gold plating prevents the electrons from interacting with surface, and therefore gives an accurate image of the smooth surface topography of the DLC film. FIG. 4 shows a cross section of a silicon substrate coated with DLC. The three distinct layers shown are the silicon substrate, an intermediate layer of silicon carbide, and the upper layer of diamond-like carbon.

### Example 4

### Preparation of Ceramics from High MW PMSi

In another example of preparing a ceramic, a high MW poly(methylsilyne) (“PMSi”) is dissolved in THF and the resulting polymer precursor solution spun onto silicon and alumina substrates. The resulting coatings are then heated under an argon atmosphere to a temperature of about 1000° C. to effect pyrolysis of the coatings. The silicon carbide (SiC) ceramic coatings or films that are formed will be either black in color or a light brown to pale yellow coloration, which is indicative of high purity silicon carbide. The purity levels of these materials can be confirmed by elemental analysis.

Energy dispersive spectroscopy (EDS) analysis of the SiC ceramic coatings or films formed from poly(methylsilyne) on silicon and alumina substrates reveal the high purity of the ceramic products. The samples of PMSi produce uniform and smooth films measuring 2 μm in thickness and having an Rq of 200 to 300 Å, scanned over 2 mm (when scanned over a smaller area or distance, such as 5 microns, the Rq may be even lower). After pyrolysis, smooth ceramic coatings or films having a uniform thickness of 1 μm and an Rq of 170 Å, scanned over 2 mm, can be obtained. These ceramic coatings and films are adherent to the substrates, resistant to removal by plastic adhesive tape.

### Other Embodiments

While various embodiments of the present invention have been described above, it should be understood that they have been presented by way of example only, and not limitation. For example, R substituents other than those specifically mentioned herein can be used in the polymers of the present invention. Polymers having n of approximately 800,000 have been synthesized, but no upper limit on n is known. Elements other than those specifically mentioned herein can be incorporated into the network backbone of the polymers of the present invention. Based upon the teachings herein, the appropriate starting materials and methods of synthesis can be selected to produce the desired high MW colloid-like polymers. Thus, the breadth and scope of the present invention should not be limited by any of the exemplary embodiments. Accordingly, other embodiments are within the scope of the following claims.

What is claimed is:

1. A high molecular weight polymer having recurring units of the formula
[AR]ₙ,
wherein n is at least 20,
wherein A is selected from the group consisting of carbon, silicon, germanium, and tin atoms, Group 13 through Group 16 elements and compounds thereof, Group 4 metals and compounds thereof, lanthanide elements, transition metals, and combinations thereof,
R is the same as A or different, and is selected from the group consisting of hydrogen atoms, saturated linear or branched-chain hydrocarbons containing from about 1 to 30 carbon atoms, unsaturated ring-containing or ring hydrocarbons containing from about 5 to 14 carbon atoms in the ring, polymer chain groups having at least 20 recurring structural units, halogens, Group 13 through Group 16 elements and compounds thereof, Group 4 metals and compounds thereof, lanthanide elements, transition metals, organic groups or polymers containing one or more heteroatoms of N, O, or S, halogens, Group 13 through Group 16 elements, Group 4 metals, lanthanide elements, transition metals and combinations thereof, and R can be the same or different within each recurring structural unit,
and the molecular weight of the polymer is at least 10,000 daltons.

2. The polymer of claim 1, wherein A comprises about 100% carbon.

3. The polymer of claim 1, wherein A comprises about 100% silicon.

4. The polymer of claim 1, wherein A comprises about 50% carbon and about 50% silicon.

5. The polymer of claim 1, wherein the molecular weight of the polymer is at least 50,000 daltons.

6. The polymer of claim 1, wherein the molecular weight of the polymer is at least 100,000 daltons.

7. The polymer of claim 1, wherein the molecular weight of the polymer is at least 500,000 daltons.

8. The polymer of claim 1, wherein the molecular weight of the polymer is at least 1,000,000 daltons.

9. The polymer of claim 1, wherein each atom of the polymer backbone is tetrahedrally-hybridized and bound via single bonds to either three other backbone atoms and one substituent, or four other backbone atoms.

10. The polymer of claim 1, wherein n is greater than 1,500.

11. The polymer of claim 1, wherein n is greater than 50,000.

12. The polymer of claim 1, wherein n is greater than 100,000.

13. The polymer of claim 1, wherein n is greater than 500,000.

14. The polymer of claim 1, wherein n is greater than 800,000.

15. The polymer of claim 1, wherein R is a single substituent.

16. The polymer of claim 1, wherein R is a mixture of different substituents.

17. A high molecular weight polymer having recurring units of the formula
[AR]ₙ,
wherein n is at least 20,
wherein A is selected from the group consisting of a carbon atom, a germanium atom, a tin atom, an element or compound of Groups 13, 15, or 16, a Group 4 metal or compound, a lanthanide element, a transition metal, and combinations thereof,
R is the same as A or different, and is selected from the group consisting of hydrogen atoms, saturated linear or branched-chain hydrocarbons containing from about 1 to 30 carbon atoms, unsaturated ring-containing or ring hydrocarbons containing from about 5 to 14 carbon atoms in the ring, polymer chain groups having at least 20 recurring structural units, halogens, Group 13, 15, or 16 elements and compounds thereof, Group 4 metals and compounds thereof, lanthanide elements, transition metals, organic groups or polymers containing one or more heteroatoms of N, O, or S, halogens, Group 13, 15, or 16 elements, Group 4 metals, lanthanide elements, transition metals and combinations thereof, and R can be the same or different within each recurring structural unit,
and the molecular weight of the polymer is at least 10,000 daltons.

18. A high molecular weight polymer having recurring units of the formula [AR]ₙ, wherein
n is at least 20;
A is selected from the group consisting of carbon, silicon, germanium, tin, and combinations thereof;
R is the same as A or different, and is selected from the group consisting of hydrogen atoms, saturated linear or branched-chain hydrocarbons containing from about 1 to 30 carbon atoms, unsaturated ring-containing or ring hydrocarbons containing from about 5 to 14 carbon atoms in the ring, each in substituted or unsubstituted form, halogens, carbon, silicon, germanium, tin, boron, phosphorous, arsenic, nitrogen, oxygen, titanium, manganese, ruthenium, cobalt, platinum, palladium, zirconium, chromium, molybdenum, and combinations thereof;
R is the same or different within each recurring structural unit; and
the molecular weight of the polymer is at least 10,000 daltons.

19. The polymer of claim 18, wherein R is hydrogen.

20. The polymer of claim 18, wherein R is a methyl group.

21. The polymer of claim 18, wherein R is a phenyl group.

22. A high molecular weight polymer having recurring units of the formula [CH]ₙ, where n is at least 20, and the molecular weight of the polymer is at least 10,000 daltons.

23. The polymer of claim 22, wherein the molecular weight of the polymer is at least 50,000 daltons.

24. The polymer of claim 22, wherein the molecular weight of the polymer is at least 100,000 daltons.

25. The polymer of claim 22, wherein the molecular weight of the polymer is at least 500,000 daltons.

26. A method of preparing a high molecular weight polymer, the method comprising:
preparing a mixture including at least two organic, oxygen-containing solvents and a reducing agent, wherein the solvents do not chemically react with the reducing agent;
homogenizing the mixture to disperse particles of the reducing agent into the solvents; and
slowly adding one or more backbone atom-containing monomers to the homogenized mixture to form a reaction mixture;
quenching the reaction mixture; and
isolating a high molecular weight polymer.

27. The method of claim 26, further comprising removing salts from the polymer and end-capping the polymer by reacting terminal halide sites with one or more nucleophiles.

28. The method of claim 26, wherein the mixture is homogenized with ultrasound.

29. The method of claim 26, wherein the mixture is homogenized by irradiation with high-intensity ultrasound at a power level of between about 20 to about 475 watts.

30. The method of claim 26, wherein the backbone atom-containing monomer has the formula AR, wherein A is selected from the group consisting of carbon, silicon, germanium, and tin atoms, Group 13 through Group 16 elements and compounds thereof, Group 4 metals and compounds thereof, lanthanide elements, transition metals, and combinations thereof, and R is the same as A or different, and is selected from the group consisting of hydrogen atoms, saturated linear or branched-chain hydrocarbons containing from about 1 to 30 carbon atoms, unsaturated ring-containing or ring hydrocarbons containing from about 5 to 14 carbon atoms in the ring, polymer chain groups having at least 20 recurring structural units, halogens, Group 13 through Group 16 elements and compounds thereof, Group 4 metals and compounds thereof, lanthanide elements, transition metals, organic groups or polymers containing one or more heteroatoms of N, O, or S, halogens, Group 13 through Group 16 elements, Group 4 metals, lanthanide elements, transition metals, and combinations thereof.

31. The method of claim 26, wherein the backbone atom-containing monomer has the formula AR, wherein A is selected from the group consisting of carbon, silicon, germanium, tin, and combinations thereof, and R is the same as A or different, and is selected from the group consisting of hydrogen atoms, saturated linear or branched-chain hydrocarbons containing from about 1 to 30 carbon atoms, unsaturated ring-containing or ring hydrocarbons containing from about 5 to 14 carbon atoms in the ring, each in substituted or unsubstituted form, halogens, carbon, silicon, germanium, tin, boron, phosphorous, arsenic, nitrogen, oxygen, titanium, manganese, ruthenium, cobalt, platinum, palladium, zirconium, chromium, molybdenum, and combinations thereof.

32. The method of claim 26, wherein the backbone atom-containing monomer is selected from the group consisting of CHBr₃, RSiCl₃, RCBr₃, RCI₃, RSnX₃, and RGeX₃, wherein X is a halogen.

33. The method of claim 26, wherein the at least two solvents are both ethers.

34. The method of claim 26, wherein the at least two solvents are tetrahydrofuran and diglyme.

35. The method of claim 26, wherein water is used to quench the reaction mixture.

36. The method of claim 27, wherein the at least two organic solvents are tetrahydrofuran and bis(2-methoxyethyl)ether, the reducing agent is sodium-potassium alloy, and the back-bone atom-containing monomer is bromoform, wherein the bromoform is added drop-wise to the homogenized mixture.

37. A method of preparing a high molecular weight polymer, the method comprising:
preparing a first mixture including at least two organic, oxygen-containing solvents and a reducing agent, wherein the solvents do not chemically react with the reducing agent;
homogenizing the first mixture to disperse the reducing agent into the solvents;
preparing a second mixture including one or more backbone atom-containing monomers and at least one organic, oxygen-containing solvent;
homogenizing the second mixture to disperse the monomer into the solvent;
slowly adding the first homogenized mixture to the second homogenized mixture to form a reaction mixture;
quenching the reaction mixture; and
isolating a high molecular weight polymer.

38. A method of end-capping high molecular weight polymers of formula [CH]ₙ, where n is at least 20 and the molecular weight of the polymers is at least 10,000 daltons, the method comprising:
(a) reacting one or more of the high molecular weight polymers with one or more hydriding agents; or
(b) forming an ionized polycarbyne and then removing excess electrons with an acidic or weak oxidizing agent;
until the high molecular polymers are neutral in charge.

39. The method of claim 38, wherein the hydriding agent is potassium hydride.

40. A method of producing diamond-like carbon or ceramic material from the high molecular weight polymer of claim 1, the method comprising:
(a) mixing one or more of the polymers in an organic solvent or supercritical fluid to form a polymer precursor mixture;
(b) applying the polymer precursor mixture to a substrate surface to form a coating or pouring the polymer precursor mixture into a mold; and
(c) pyrolyzing the coating or the mixture contained in the mold under an inert atmosphere at a temperature of about 100° to 1600° C.

41. The method of claim 40, further including repeating steps (a)-(c), to increase the thickness of the substrate coating.

42. The method of claim 40, wherein the solvent is selected from the group consisting of ethers, toluene, amines, dimethyl sulfoxide, chlorocarbon solvents, and mixtures thereof.

43. The method of claim 40, wherein the substrate is selected from the group consisting of silicon, silica, aluminum, alumina, magnesium, transition metal oxides, and metals.

44. The method of claim 40, wherein the resulting ceramic has a surface mean square roughness (Rq) of less than 5000 Å, scanned over 5 microns.

45. The method of claim 40, wherein the resulting ceramic has a surface mean square roughness (Rq) of less than 500 Å, scanned over 5 microns.

46. A method of modifying the high molecular weight polymer of claim 1, the method comprising
reacting one or more of the high molecular weight polymers with one or more free radical initiators and one or more halogenating agents to produce halogenated polymers.

47. The method of claim 46, wherein the one or more free radical initiators is azobisisobutyronitrile and the halogenating agent is N-bromosuccinimide.

48. A method of modifying the high molecular weight polymer of claim 1, the method comprising
reacting one or more of the high molecular weight polymers with one or more acid reagents, one or more reducing agents, or one or more oxidizing agents to produce polyanionic or polycationic polymers.

49. The method of claim 48, wherein the acid reagent is an acid reagent is a multinuclear acid.

50. The method of claim 48, wherein the reducing agent is selected from the group consisting of borohydrides, Group 2 hydrides, potassium hydride, and sodium hydride, and the oxidizing agent is selected from the group consisting of chlorine, chlorites, halogens, hypochlorites, nitrates, perchlorates, peroxides, and transition metal oxides.

51. The method of claim 48, further comprising exchanging cations or anions present in the polyanionic or polycationic polymers with ions selected from the group consisting of halides, cyanides, nitrates, nitrosos, borates, anions, alkali and alkaline earth metals, transition metals and complexes thereof, and cations and combinations thereof, and recovering the ionized high molecular weight polymers.

52. The method of claim 48, wherein the high molecular weight polymer is polyphenylcarbyne.

53. A method of modifying high molecular weight polymers of the formula [SiPh]ₙ, where n is at least 20, and the molecular weight of the high molecular weight polymers is at least 10,000 daltons, the method comprising
mixing the high molecular weight polymers in a suitable solvent; and
reacting the high molecular weight polymers with one or more acid reagents to produce polycationic polymers.

54. The method of claim 53, wherein suitable acid reagents are non-oxidizing acid reagents of the formula HX, wherein X is selected from the group consisting of Group 17 elements, borate acid, and trifluoromethanesulfonic acid.

55. The method of claim 53, wherein the acid reagent is trifluoromethanesulfonic acid.
